(19) United States
(12) Patent Application Publication
(10) Pub. No.: US 2025/0360468 A1
(43) Pub. Date: Nov. 27, 2025

(54) SEPARATION MEMBRANE COMPLEX AND METHOD OF PRODUCING SEPARATION MEMBRANE COMPLEX

(71) Applicant: NGK INSULATORS, LTD., Nagoya-City (JP)

(72) Inventors: Makoto MIYAHARA, Tajimi-Shi (JP); Kenichi NODA, Nagoya-Shi (JP); Tomoyo AKAHIRA, Nagoya-Shi (JP); Daiki KAZAOKA, Tokai-Shi (JP)

(73) Assignee: NGK INSULATORS, LTD., Nagoya-City (JP)

(21) Appl. No.: 19/289,338

(22) Filed: Aug. 4, 2025

Related U.S. Application Data
(63) Continuation of application No. PCT/JP2023/046745, filed on Dec. 26, 2023.

(30) Foreign Application Priority Data
Mar. 10, 2023 (JP) 2023-037303

(51) Int. Cl. B01D 71/06; B01D 67/00; B01D 69/10; B01D 71/02

(52) U.S. Cl. CPC B01D 71/06; B01D 67/00793; B01D 69/108; B01D 71/022; B01D 2325/20

(57) ABSTRACT

A separation membrane complex includes a porous support formed of ceramic and a separation membrane which is formed on the support and composed of metal organic framework. An average thickness of the separation membrane is not larger than 2 μm. The metal organic framework is composed of aluminum ions and ligands coordinated to the aluminum ions. A powder X-ray diffraction pattern of the metal organic framework has peaks at predetermined diffraction angles 2θ. In the separation membrane complex, a permeance ratio of SF₆/He is not higher than 0.020.

### CROSS-REFERENCE TO RELATED APPLICATIONS

The present application is a continuation application of International Application No. PCT/JP2023/046745 filed on Dec. 26, 2023, which claims priority to Japanese Patent Application No. 2023-037303 filed on Mar. 10, 2023. The contents of these applications are incorporated herein by reference in their entirety.

### TECHNICAL FIELD

The present invention relates to a separation membrane complex and a method of producing a separation membrane complex.

### BACKGROUND ART

In the global trend towards carbon neutrality, social needs for a technique (CO₂/N₂ separation) for separating and collecting CO₂ contained in industrial emissions discharged from plants or the like have increased. Since a high CO₂/N₂ separation factor is hard to achieve in separation by a molecular sieving mechanism using a DDR-type zeolite membrane or a CHA-type zeolite membrane which is high-silica zeolite, required is a separation membrane which can achieve a high separation factor by giving affinity with CO₂ thereto, additionally to the molecular sieving mechanism.

Metal organic framework (MOF) is a porous material having a large surface area and is a material which can be applied to any of various purposes of use such as gas adsorption or the like. Further, like a zeolite membrane or the like, by forming a membrane on a porous support, application to gas or liquid separation can be expected. When MOF which has a small pore diameter and includes ligands having high affinity with CO₂ is used, there is a possibility to achieve a high CO₂/N₂ separation factor. In “Multivariate Polycrystalline Metal-Organic Framework Membranes for CO₂/CH₄ Separation” by Weidong Fan and nine others (J. Am. Chem. Soc., 2021, Vol. 143, pp. 17716 to 17723) (Document 1) and “Conformational-change-induced selectivity enhancement of CAU-10-PDC membrane for H₂/CH₄ and CO₂/CH₄ separation” by Chung-Kai Chang and seven others (Journal of Membrane Science Letters, 2021, Vol. 1, p. 100005) (Document 2), for example, disclosed is a structure in which a MOF membrane is formed on a ceramic support, and a permeance ratio of CO₂/N₂ or that of CO₂/CH₄ shows a relatively high value.

As to the performance of a separation membrane, important is a permeance (permeability of a high permeability substance), as well as the separation factor. By increasing the permeance, it is possible to reduce the number of separation membrane complexes needed to construct a separation apparatus and to thereby achieve reduction in the manufacturing cost of the separation apparatus and reduction in the size of the separation apparatus. In the MOF membrane disclosed in Non-Patent Documents 1 and 2, however, since the thickness is large, the permeance is low. Though thinning of the membrane is a possible method in order to increase the permeance in the MOF membrane, effects of a grain boundary defect which refers to formation of an excessively large gap between crystals of the MOF, a coordination defect which refers to a lack of some ligands constituting the MOF, and/or the like usually become noticeable, and it thereby becomes impossible to achieve a high separation factor. Therefore, a separation membrane complex having both a high separation factor and a high permeance is required.

### SUMMARY OF THE INVENTION

It is an object of the present invention to provide a separation membrane complex having both a high separation factor and a high permeance.

A first aspect of the present invention is intended for a separation membrane complex, and the separation membrane complex according to the first aspect includes a porous support formed of ceramic and a separation membrane which is formed on the support and composed of metal organic framework, and in the separation membrane complex of the first aspect, an average thickness of the separation membrane is not larger than 2 μm, the metal organic framework is composed of aluminum ions and ligands coordinated to the aluminum ions, a powder X-ray diffraction pattern of the metal organic framework has peaks at diffraction angles 2θ shown in Table below, and a permeance ratio of SF₆/He is not higher than 0.020.

TABLE 1

| | 2θ [°] |
|---|---|
| [symbol] | 8.2-8.4 |
| [symbol] | 9.1-9.3 |
| [symbol] | 11.8-12.0 |
| [symbol] | 12.4-12.6 |
| [symbol] | 14.9-15.1 |
| [symbol] | 16.7-16.9 |
| [symbol] | 17.1-17.3 |
| [symbol] | 18.4-18.6 |
| [symbol] | 19.1-19.3 |
| [symbol] | 22.5-22.7 |
| [symbol] | 24.3-24.5 |
| [symbol] | 25.1-25.3 |
| [symbol] | 26.9-27.1 |

According to the present invention, it is possible to provide a separation membrane complex having both a high separation factor and a high permeance.

A second aspect of the present invention is intended for the separation membrane complex according to the first aspect, and in the separation membrane complex according to the second aspect, an average particle diameter of the metal organic framework is 0.1 μm to 2 μm.

A third aspect of the present invention is intended for the separation membrane complex according to the first or second aspect, and in the separation membrane complex according to the third aspect, the ligands of the metal organic framework contain any one of 1H-Pyrrole-2,5-dicarboxylic acid, 2,5-Furandicarboxylic acid, and 3,5-Pyridinedicarboxylic acid.

A fourth aspect of the present invention is intended for the separation membrane complex according to any one of the first to third aspects, and in the separation membrane complex according to the fourth aspect, a thickness of a composite layer of the support and the metal organic framework is not larger than 2 μm.

A fifth aspect of the present invention is intended for the separation membrane complex according to any one of the first to fourth aspects, and in the separation membrane complex according to the fifth aspect, a permeance of CO₂ gas is not lower than 1000 GPU.

A sixth aspect of the present invention is intended for a method of producing a separation membrane complex, and the method of producing a separation membrane complex according to the sixth aspect includes a) depositing seed crystals composed of metal organic framework onto a porous support, b) preparing a synthesis solution, and c) forming a separation membrane on the support by immersing the support in the synthesis solution and performing hydrothermal synthesis to grow metal organic framework from the seed crystals, and in the method of producing a separation membrane complex according to the sixth aspect, the operation b) includes a heating and stirring process for heating and stirring a solution in which water, monocarboxylic acid salt, and ligands are mixed, an aluminum source is mixed into the solution after the heating and stirring process and an organic solvent is mixed into the solution at arbitrary timing in the operation b), and a permeance ratio of SF₆/He is not higher than 0.020 in a separation membrane complex in which the separation membrane is formed on the support.

A seventh aspect of the present invention is intended for the method of producing a separation membrane complex according to the sixth aspect, and in the method of producing a separation membrane complex according to the seventh aspect, the organic solvent is an organic compound having a carbonyl group, and a ratio of an amount of substance of the organic solvent to that of the ligands is 0.1 to 10 in the synthesis solution.

An eighth aspect of the present invention is intended for the method of producing a separation membrane complex according to the sixth or seventh aspect, and in the method of producing a separation membrane complex according to the eighth aspect, a ratio of an amount of substance of the monocarboxylic acid salt to that of the ligands is 0.5 to 1.8 in the synthesis solution.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a cross-sectional view of a separation membrane complex;

FIG. 2 is a cross-sectional view enlargedly showing part of the separation membrane complex;

FIG. 3 is a flowchart showing a flow for producing the separation membrane complex;

FIG. 4 is a view showing a separation apparatus;

FIG. 5 is a flowchart showing a flow for separating a mixed substance by the separation apparatus;

FIG. 6A is a view used for explaining synthesis of a separation membrane in Comparative Example;

FIG. 6B is a view used for explaining synthesis of the separation membrane in Comparative Example;

FIG. 7A is a view used for explaining synthesis of a separation membrane; and

FIG. 7B is a view used for explaining synthesis of the separation membrane.

### DETAILED DESCRIPTION

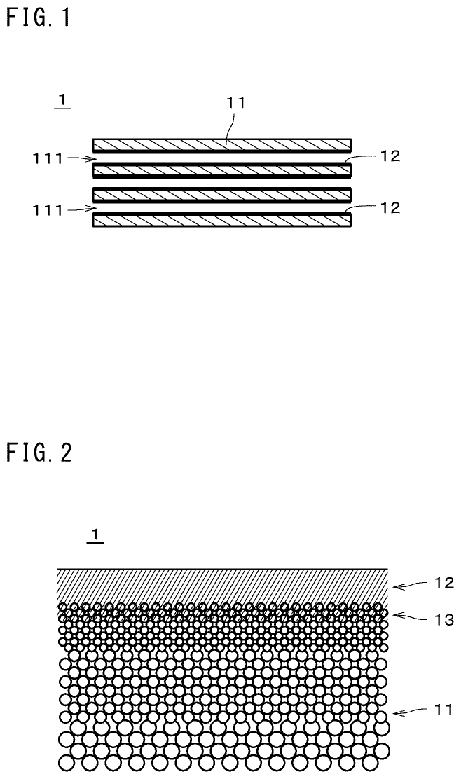

FIG. 1 is a cross-sectional view of a separation membrane complex 1. FIG. 2 is a cross-sectional view enlargedly showing part of the separation membrane complex 1. The separation membrane complex 1 includes a porous support 11 and a separation membrane 12 formed on the support 11. As described later, the separation membrane 12 is a MOF membrane formed of metal organic framework (hereinafter, referred to as “MOF”), and the separation membrane complex 1 is a MOF membrane complex. The MOF membrane is at least obtained by forming MOF on a surface of the support 11 in a membrane form and does not include a membrane obtained by simply dispersing MOF particles in an organic membrane. In FIG. 1, the separation membrane 12 is represented by a thick line. In FIG. 2, the separation membrane 12 is hatched. Further, in FIG. 2, the thickness of the separation membrane 12 is shown larger than the actual one.

The support 11 is a porous member that gas and liquid can permeate. In the exemplary case shown in FIG. 1, the support 11 is a monolith-type support having an integrally and continuously molded columnar main body provided with a plurality of through holes 111 extending in a longitudinal direction (i.e., a left and right direction in FIG. 1). In the exemplary case shown in FIG. 1, the support 11 has a substantially circular columnar shape. A cross section perpendicular to the longitudinal direction of each of the through holes 111 (i.e., cells) is, for example, substantially circular. In FIG. 1, the diameter of each through hole 111 is larger than the actual diameter, and the number of through holes 111 is smaller than the actual number. The separation membrane 12 is formed on an inner surface of each through hole 111, covering substantially the entire inner surface of the through hole 111.

The length of the support 11 (i.e., the length in the left and right direction of FIG. 1) is, for example, 10 cm to 200 cm. The outer diameter of the support 11 is, for example, 0.5 cm to 30 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

The support 11 is formed of ceramic. Examples of a ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite. The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the separation membrane 12 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the separation membrane 12 is formed is, for example, 20% to 60%.

The support 11 has, for example, a multilayer structure in which a plurality of layers with different average pore diameters are layered in a thickness direction. The average pore diameter and the sintered particle diameter in a surface layer including the surface on which the separation membrane 12 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another. Further, when the support 11 has a multilayer structure, the average pore diameter of the support 11 refers to the average pore diameter in the surface layer including the surface on which the separation membranes 12 is formed.

The separation membrane 12 is a porous membrane having micropores. The separation membrane 12 can separate a specific substance from a mixed substance in which a plurality of types of substances are mixed together, by using a molecular sieving function or the like. As compared with the specific substance, any one of the other substances is harder to permeate the separation membrane 12. In other words, the permeance of any other substance through the separation membrane 12 is lower than that of the above-described specific substance.

An average thickness of the separation membrane 12 is not larger than 2 μm. It is thereby possible to achieve a high permeance. A lower limit of the average thickness of the separation membrane 12 is not particularly limited, but in terms of an increase in the separation performance, the lower limit of the average thickness of the separation membrane 12 is, for example, 0.2 μm, preferably 0.5 μm, and more preferably 0.7 μm. In the measurement of the average thickness of the separation membrane 12, a cross section perpendicular to a surface of the separation membrane 12 is exposed by, for example, cross section polishing. In the cross section, a plurality of fields of view (e.g., seven fields of view) which are randomly determined are observed by a scanning electron microscope (SEM). The magnification of the SEM is, for example, 5000 times. The average thickness (visual field average thickness) of the separation membrane 12 in each field of view is obtained, and the arithmetic average of the visual field average thicknesses in the remaining fields of view obtained by excluding the fields of view having the largest value and the smallest value of the visual field average thickness is acquired as the average thickness of the separation membrane 12. The surface roughness (Ra) of the separation membrane 12 is, for example, 2 μm or less, preferably 1 μm or less, and more preferably 0.5 μm or less.

As described above, the separation membrane 12 is formed of MOF. In other words, the separation membrane 12 is a MOF membrane. Though the separation membrane 12 is typically formed only of MOF, depending on the production method or the like, the separation membrane 12 may also slightly contain any substance (e.g., 1 mass % or less) other than the MOF. The pore diameter of the MOF composing the separation membrane 12 is, for example, 1 nm or less. The pore diameter can be calculated from the framework structure of the MOF crystals. The pore diameter is smaller than the average pore diameter of the support 11 in the vicinity of the surface on which the separation membrane 12 is formed.

The average particle diameter of the MOF composing the separation membrane 12 is, for example, 0.1 μm to 2 μm. The average particle diameter is preferably 1 μm or less, and more preferably 0.5 μm or less. In the separation membrane 12 composed of the MOF having a small average particle diameter, it is possible to reduce a grain boundary defect which refers to formation of an excessively large gap between crystals of the MOF and to thereby increase the separation performance. The average particle diameter of the MOF in the present preferred embodiment is the arithmetic average of the respective largest diameters of a plurality of particles (e.g., 30 particles) measured by the cross-sectional observation using the SEM. The plurality of particles to be measured may be randomly selected on an image obtained by the SEM.

In an interface between the separation membrane 12 and the support 11, formed is a composite layer 13 in which the MOF crystals enter the inside of the pores of the support 11. In FIG. 2, the composite layer 13 is represented by hatching part of the support 11 overlappingly. The composite layer 13 is part of the support 11. The thickness of the composite layer 13 is, for example, not larger than 2 μm. It thereby becomes possible to suppress reduction in the permeance due to the existence of the composite layer 13. The composite layer 13 does not have to be present, and a lower limit value of the thickness of the composite layer 13 is 0.

In the measurement of the thickness of the composite layer 13, in the cross-sectional observation using the SEM, specified are boundary positions of the composite layer 13 in a direction (hereinafter, referred to as a “depth direction”) perpendicular to the interface between the support 11 and the separation membrane 12 in the vicinity of one measurement position in a direction along the interface. In more detail, the boundary position of the composite layer 13 on the side of the separation membrane 12 is the interface between the separation membrane 12 and the support 11. The boundary position of the composite layer 13 on the other side opposite to the separation membrane 12 is an edge of the MOF farthest away from the separation membrane 12 in the depth direction among the MOFs present in the pores of the support 11. The distance between the boundary position of the composite layer 13 on the side of the separation membrane 12 and that on the other side opposite to the separation membrane 12 in the depth direction is acquired as the thickness of the composite layer 13 at the measurement position. Then, an average of the thicknesses of the composite layer 13 at a plurality of different measurement positions (e.g., 10 measurement positions) is determined as the thickness of the composite layer 13 in the separation membrane complex 1.

The MOF composing the separation membrane 12 is composed of aluminum ions (Al³⁺) and ligands (organic ligands) coordinated to the aluminum ions. It is preferable that the ligands should have high affinity with CO₂, and the ligands contain, for example, 1H-Pyrrole-2,5-dicarboxylic acid, 2,5-Furandicarboxylic acid, or 3,5-Pyridinedicarboxylic acid. Depending on the type of a substance to be separated, any other ligands may be used. A powder X-ray diffraction (XRD) pattern of the MOF of the separation membrane 12 has peaks at all diffraction angles 2θ shown in Table 2.

TABLE 2

| | 2θ [°] |
|---|---|
| [symbol] | 8.2-8.4 |
| [symbol] | 9.1-9.3 |
| [symbol] | 11.8-12.0 |
| [symbol] | 12.4-12.6 |
| [symbol] | 14.9-15.1 |
| [symbol] | 16.7-16.9 |
| [symbol] | 17.1-17.3 |
| [symbol] | 18.4-18.6 |
| [symbol] | 19.1-19.3 |
| [symbol] | 22.5-22.7 |
| [symbol] | 24.3-24.5 |
| [symbol] | 25.1-25.3 |
| [symbol] | 26.9-27.1 |

The powder X-ray diffraction pattern is acquired by using a CuKα ray as a radiation source of an X-ray diffraction apparatus. For example, an X-ray diffraction apparatus manufactured by Rigaku Corporation (apparatus name: MiniFlex 600) is used on the condition that the tube voltage is 40 kV, the tube current is 15 mA, the scanning speed is 0.5° /min, and the scanning step is 0.02°. Further, other conditions are that the divergence slit is 1.25°, the scattering slit is 1.25°, the receiving slit is 0.3 mm, the incident solar slit is 5.0°, and the light-receiving solar slit is 5.0°. No monochromator is used, and as a CuKβ ray filter, used is a nickel foil having a thickness of 0.015 mm.

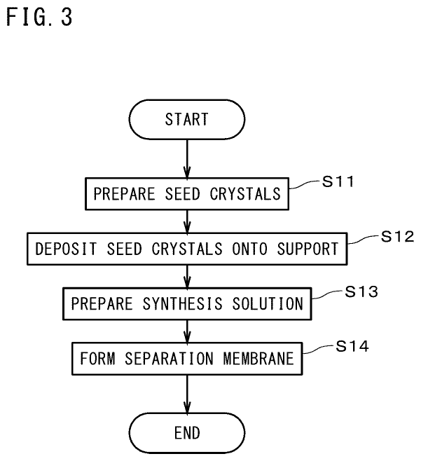

Next, with reference to FIG. 3, an exemplary flow of producing the separation membrane complex 1 will be described. In production of the separation membrane complex 1, first, seed crystals to be used for production of the separation membrane 12 are prepared (Step S11). As to the seed crystals, for example, MOF powder is synthesized by hydrothermal synthesis (solvothermal synthesis), and the seed crystals are acquired from the MOF powder. The MOF powder may be synthesized by any or well-known production method. The MOF powder as-is may be used as the seed crystals, or may be processed by pulverization or the like, to thereby acquire the seed crystals.

The average particle diameter (D50) of the seed crystals is preferably not larger than 0.5 μm. It thereby becomes possible to suppress occurrence of the grain boundary defect due to an excessive increase in the average particle diameter of the MOF. A lower limit of the average particle diameter of the seed crystals is not particularly limited, but by setting the average particle diameter to be not smaller than 0.1 μm, for example, it is possible to suppress reduction in the crystallinity of the seed crystals. The average particle diameter of the seed crystals can be measured by, for example, a laser scattering method.

Subsequently, the porous support 11 is immersed in a dispersion liquid in which the seed crystals are dispersed, and the seed crystals are thereby deposited onto the support 11 (Step S12). Alternatively, the dispersion liquid in which the seed crystals are dispersed is brought into contact with a portion on the support 11 where the separation membrane 12 is to be formed, and the seed crystals are thereby deposited onto the support 11. A support with seed crystals deposited thereon is thereby produced. The seed crystals may be deposited onto the support 11 by any other method.

Further, a synthesis solution (also referred to as a synthetic sol or a starting material solution) to be used for forming the separation membrane 12 is produced and prepared (Step S13). Preparation of the synthesis solution may be performed before Step S12 or may be performed concurrently with Step S12. In the preparation of the synthesis solution, first, water, monocarboxylic acid salt, the ligands, and an organic solvent are mixed. Monocarboxylic acid salt is, for example, formate such as sodium formate, lithium formate, potassium formate, or the like or acetate such as sodium acetate or the like. Monocarboxylic acid serves as a modulator in MOF synthesis and contributes to an increase in the crystallinity. Therefore, amino acid (e.g., glycine, arginine, or the like) containing monocarboxylic acid may be used. As to the ligands, in the MOF which is synthesized by using the ligands, only if the powder X-ray diffraction pattern having peaks at the diffraction angles 2θ shown in Table 2 can be obtained, any of various organic compounds can be used. Preferable ligands are organic compounds having high affinity with CO₂ and are, for example, 1H-Pyrrole-2,5-dicarboxylic acid, 2,5-Furandicarboxylic acid, 3,5-Pyridinedicarboxylic acid, or the like. A preferable organic solvent is an organic compound having a carbonyl group (carboxyl group or the like) and is, for example, N,N-dimethylformamide (DMF), N-Methyl-2-pyrrolidone (NMP), N-Methylformamide, or the like. An organic solvent having no carbonyl group may be used.

In the synthesis solution, a ratio of the amount of substance of monocarboxylic acid salt to that of the ligands (hereinafter, also referred to as a “ratio of monocarboxylic acid salt/ligands”) is preferably 0.5 to 1.8. In a case where no monocarboxylic acid salt is added, even when a heating and stirring process described later is performed, the synthesis solution becomes cloudy and the uniformity is reduced, and the MOF thereby becomes hard to generate. On the other hand, when monocarboxylic acid salt is excessively added, as described later, a coordination defect which refers to a lack of some ligands constituting the MOF becomes easier to occur. Further, a ratio of the amount of substance of the organic solvent to that of the ligands (hereinafter, also referred to as a “ratio of organic solvent/ligands”) is preferably 0.1 to 10. In a case where no organic solvent is added, the crystallinity of the MOF is reduced. On the other hand, when the organic solvent is excessively added, as described later, the coordination defect becomes easier to occur.

After obtaining a solution in which water, monocarboxylic acid salt, the ligands, and the organic solvent are mixed, a heating and stirring process (aging) for heating and stirring the solution is performed. The heating temperature in the heating and stirring process is, for example, 20 to 100° C., and preferably 40 to 80° C. The processing time is, for example, 1 to 100 hours, and preferably 1 to 12 hours. After the heating and stirring process is finished, an aluminum source (Al source) is mixed into the solution. The Al source is, for example, aluminum sulfate, aluminum chloride, aluminum nitrate, aluminum hydroxide, boehmite, or the like. Thus, the synthesis solution to be used for forming the separation membrane 12 is obtained. Further, mixing of the organic solvent into the solution does not necessarily need to be performed before the heating and stirring process, but may be performed during the heating and stirring process or after the heating and stirring process. In other words, the organic solvent may be mixed into the above-described solution at arbitrary timing.

After the synthesis solution is prepared, the support 11 on which the seed crystals are deposited is immersed in the synthesis solution. After that, by heating the synthesis solution, the hydrothermal synthesis is started. In the hydrothermal synthesis, the MOF is caused to grow from the seed crystals as nuclei, to thereby form the separation membrane 12 which is a dense MOF membrane on the support 11 (Step S14). The synthesis temperature (the heating temperature of the synthesis solution) in the hydrothermal synthesis is, for example, 40° C. to 200° C., and preferably 70° C. to 150° C. The hydrothermal synthesis time is, for example, 1 to 100 hours, and preferably 1 to 50 hours.

After the hydrothermal synthesis is finished, the support 11 and the separation membrane 12 are washed with pure water and then washed with ethanol or the like. Preferably, washing with water and ethanol or the like is repeated a plurality of times. After washing, the support 11 and the separation membrane 12 are dried, for example, at 100° C. By the above process, the above-described separation membrane complex 1 is obtained.

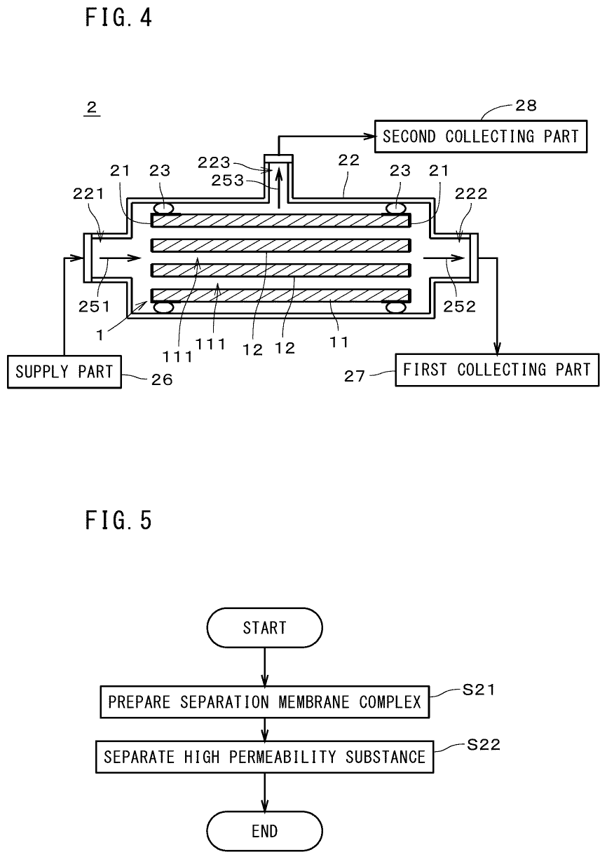

Next, with reference to FIGS. 4 and 5, separation of a mixed substance by using the separation membrane complex 1 will be described. FIG. 4 is a view showing a separation apparatus 2. FIG. 5 is a flowchart showing a flow of separating the mixed substance by the separation apparatus 2.

In the separation apparatus 2, a mixed substance containing a plurality of types of fluids (i.e., gases or liquids) is supplied to the separation membrane complex 1, and a substance with high permeability in the mixed substance is caused to permeate the separation membrane complex 1, to be thereby separated from the mixed substance. Separation in the separation apparatus 2 may be performed, for example, in order to extract a substance with high permeability from a mixed substance, or in order to concentrate a substance with low permeability.

The mixed substance (i.e., mixed fluid) may be a mixed gas containing a plurality of types of gases, may be a mixed liquid containing a plurality of types of liquids, or may be a gas-liquid two-phase fluid containing both a gas and a liquid.

The mixed substance contains at least one type of, for example, hydrogen (H₂), helium (He), nitrogen (N₂), oxygen (O₂), water (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde.

The nitrogen oxide is a compound of nitrogen and oxygen. The above-described nitrogen oxide is, for example, a gas called NO_{X} such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SO_{X} such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S═SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH (CH₃)₃), 1-butene (CH₂═CHCH₂CH₃), 2-butene (CH₃CH═CHCH₃), or isobutene (CH₂═C(CH₃)₂).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

In the following description, it is assumed that the mixed substance to be separated by the separation apparatus 2 is a mixed gas containing a plurality of types of gases.

The separation apparatus 2 includes the separation membrane complex 1, sealing parts 21, a housing 22, two sealing members 23, a supply part 26, a first collecting part 27, and a second collecting part 28. The separation membrane complex 1, the sealing parts 21, and the sealing members 23 are accommodated inside the housing 22. The supply part 26, the first collecting part 27, and the second collecting part 28 are disposed outside the housing 22 and connected to the housing 22.

The sealing parts 21 are members which are attached to both end portions in the longitudinal direction (i.e., in the left and right direction of FIG. 4) of the support 11 and cover and seal both end surfaces in the longitudinal direction of the support 11 and outer surfaces in the vicinity of the end surfaces. The sealing parts 21 prevent a gas from flowing into or out from both the end surfaces of the support 11. The sealing part 21 is, for example, a plate-like member formed of glass or a resin. The material and the shape of the sealing part 21 may be changed as appropriate. Further, since the sealing part 21 is provided with a plurality of openings which coincide with the plurality of through holes 111 of the support 11, both ends of each through hole 111 of the support 11 in the longitudinal direction are not covered with the sealing parts 21. Therefore, the gas or the like can flow into and out from the through hole 111 from both ends thereof.

There is no particular limitation on the shape of the housing 22 but is, for example, a tubular member having a substantially cylindrical shape. The housing 22 is formed of, for example, stainless steel or carbon steel. The longitudinal direction of the housing 22 is substantially in parallel to the longitudinal direction of the separation membrane complex 1. A supply port 221 is provided at an end portion on one side in the longitudinal direction of the housing 22 (i.e., an end portion on the left side in FIG. 4), and a first exhaust port 222 is provided at another end portion on the other side. A second exhaust port 223 is provided on a side surface of the housing 22. The supply part 26 is connected to the supply port 221. The first collecting part 27 is connected to the first exhaust port 222. The second collecting part 28 is connected to the second exhaust port 223. An internal space of the housing 22 is a sealed space that is isolated from the space around the housing 22.

The two sealing members 23 are arranged around the entire circumference between an outer surface of the separation membrane complex 1 and an inner surface of the housing 22 in the vicinity of both end portions of the separation membrane complex 1 in the longitudinal direction. Each of the sealing members 23 is a substantially annular member formed of a material that the gas cannot permeate. The sealing member 23 is, for example, an O-ring formed of a flexible resin. The sealing members 23 come into close contact with the outer surface of the separation membrane complex 1 and the inner surface of the housing 22 around the entire circumferences thereof. In the exemplary case of FIG. 4, the sealing members 23 come into close contact with outer surfaces of the sealing parts 21 and indirectly come into close contact with the outer surface of the separation membrane complex 1 with the sealing parts 21 interposed therebetween. The portions between the sealing members 23 and the outer surface of the separation membrane complex 1 and between the sealing members 23 and the inner surface of the housing 22 are sealed, and it is thereby mostly or completely impossible for the gas to pass through the portions.

The supply part 26 supplies the mixed gas into the internal space of the housing 22 through the supply port 221. The supply part 26 includes, for example, a blower or a pump for pumping the mixed gas toward the housing 22. The blower or the pump includes a pressure regulating part for regulating the pressure of the mixed gas to be supplied to the housing 22. The first collecting part 27 and the second collecting part 28 each include, for example, a storage container for storing the gas led out from the housing 22 or a blower or a pump for transporting the gas.

When separation of the mixed gas is performed, the above-described separation apparatus 2 is prepared and the separation membrane complex 1 is thereby prepared (Step S21). Subsequently, the supply part 26 supplies a mixed gas containing a plurality of types of gases with different permeabilities for the separation membrane 12 into the internal space of the housing 22. For example, the main component of the mixed gas includes CO₂ and N₂. The mixed gas may contain any gas other than CO₂ or N₂. The pressure (i.e., feed pressure) of the mixed gas to be supplied into the internal space of the housing 22 from the supply part 26 is, for example, 0.1 MPa to 20.0 MPa. The temperature for separation of the mixed gas is, for example, 10° C. to 150° C.

The mixed gas supplied from the supply part 26 into the housing 22 is fed from the left end of the separation membrane complex 1 in this figure into the inside of each through hole 111 of the support 11 as indicated by an arrow 251. Gas with high permeability (which is, for example, CO₂, and hereinafter is referred to as a “high permeability substance”) in the mixed gas permeates the separation membrane 12 formed on the inner surface of each through hole 111 and the support 11, and is led out from the outer surface of the support 11. The high permeability substance is thereby separated from gas with low permeability (which is, for example, N₂, and hereinafter is referred to as a “low permeability substance”) in the mixed gas (Step S22). The gas (hereinafter, referred to as a “permeate substance”) led out from the outer surface of the support 11 is collected by the second collecting part 28 through the second exhaust port 223 as indicated by an arrow 253. The pressure (i.e., permeate pressure) of the gas to be collected by the second collecting part 28 through the second exhaust port 223 is, for example, about 1 atmospheric pressure (0.101 MPa).

Further, in the mixed gas, a gas (hereinafter, referred to as a “non-permeate substance”) other than the gas which has permeated the separation membrane 12 and the support 11 passes through each through hole 111 of the support 11 from the left side to the right side in this figure and is collected by the first collecting part 27 through the first exhaust port 222 as indicated by an arrow 252. The pressure of the gas to be collected by the first collecting part 27 through the first exhaust port 222 is, for example, substantially the same as the feed pressure. The non-permeate substance may include a high permeability substance that has not permeated the separation membrane 12, as well as the above-described low permeability substance.

Next, Examples 1 to 21 and Comparative Examples 1 to 7 of the separation membrane complex will be described. Table 3 shows the type of ligands, the D50 value (average particle diameter) of the seed crystals, the ratio of monocarboxylic acid salt/ligands, the ratio of organic solvent/ligands, and conditions of the heating and stirring process in Examples 1 to 21 and Comparative Examples 1 to 7.

TABLE 3

| | | DSO | Mono- | Organic | |
|---|---|---|---|---|---|
| | | Value | carboxylic | Solvent/ | |
| | | of Seed | Acid Salt/ | Ligands | Heating and |
| | | Crystals | Ligands | (Molar | Stirring |
| | Ligands | (μm) | (Molar Ratio) | Ratio) | Conditions |
| Example 1 | 1H-Pyrrole-2,5-dicarboxylic acid | 0.33 | 1.8 | 0.8 | 60° C. × 2 h |
| Example 2 | 1H-Pyrrole-2,5-dicarboxylic acid | 0.33 | 1.8 | 0.8 | 60° C. × 2 h |
| Example 3 | 1H-Pyrrole-2,5-dicarboxylic acid | 0.33 | 1 | 0.8 | 60° C. × 2 h |
| Example 4 | 1H-Pyrrole-2,5-dicarboxylic acid | 0.33 | 0.6 | 0.8 | 60° C. × 2 h |
| Example 5 | 1H-Pyrrole-2,5-dicarboxylic acid | 0.33 | 1.8 | 0.8 | 40° C. × 5 h |
| Example 6 | 1H-Pyrrole-2,5-dicarboxylic acid | 0.33 | 1.8 | 0.8 | 80° C. × 12 h |
| Example 7 | 1H-Pyrrole-2,5-dicarboxylic acid | 0.33 | 1.8 | 0.1 | 60° C. × 2 h |
| Example 8 | 1H-Pyrrole-2,5-dicarboxylic acid | 0.33 | 1.8 | 8 | 60° C. × 2 h |
| Example 9 | 1H-Pyrrole-2,5-dicarboxylic acid | 0.33 | 1.8 | 0.8 | 60° C. × 2 h |
| Example 10 | 1H-Pyrrole-2,5-dicarboxylic acid | 0.50 | 1.8 | 0.8 | 60° C. × 2 h |
| Example 11 | 2,5-Furandicarboxylic acid | 0.25 | 1.8 | 0.8 | 60° C. × 2 h |
| Example 12 | 2,5-Furandicarboxylic acid | 0.25 | 1.8 | 0.8 | 40° C. × 2 h |
| Example 13 | 2,5-Furandicarboxylic acid | 0.25 | 1 | 0.8 | 60° C. × 2 h |
| Example 14 | 2,5-Furandicarboxylie acid | 0.25 | 1.8 | 2 | 60° C. × 2 h |
| Example 15 | 3,5-Pyridinedicarboxylic acid | 0.35 | 1.8 | 0.8 | 60° C. × 2 h |
| Example 16 | 3,5-Pyridinedicarboxylic acid | 0.35 | 1.8 | 0.8 | 40° C. × 2 h |
| Example 17 | 3,5-Pyridinedicarboxylic acid | 0.35 | 1 | 0.8 | 60° C. × 2 h |
| Example 18 | 3,5-Pyridinedicarboxylic acid | 0.35 | 1.8 | 2 | 60° C. × 2 h |
| Example 19 | 1H-Pyrrole-2,5-dicarboxylic acid | 0.33 | 1.5 | 0.5 | 60° C. × 2 h |
| | 2,5-Furandicarboxylic acid | | | | |
| Example 20 | 1H-Pyrrole-2,5-dicarboxylic acid | 0.33 | 1.5 | 0.5 | 60° C. × 2 h |
| | 3,5-Pyridinedicarboxylic acid | | | | |
| Example 21 | 2,5-Furandicarboxylic acid | 0.25 | 1.5 | 0.8 | 60° C. × 2 h |
| | 3,5-Pyridinedicarboxylic acid | | | | |
| Comparative | 1H-Pyrrole-2,5-dicarboxylic acid | 0.33 | 1.8 | 0.8 | No |
| Example 1 | | | | | |
| Comparative | 1H-Pyrrole-2,5-dicarboxylic acid | 0.33 | 0 | 0.8 | No |
| Example 2 | | | | | |
| Comparative | 1H-Pyrrole-2,5-dicarboxylic acid | 0.33 | 1.8 | 12 | 60° C. × 2 h |
| Example 3 | | | | | |
| Comparative | 1H-Pyrrole-2,5-dicarboxylic acid | 0.33 | 1.8 | 0 | 60° C. × 2 h |
| Example 4 | | | | | |
| Comparative | 2,5-Furandicarboxylic acid | — | 2 | 0 | No |
| Example 5 | | | | | |
| Comparative | 2,5-Furandicarboxylic acid | 0.25 | 2 | 0 | No |
| Example 6 | | | | | |
| Comparative | 3,5-Pyridinedicarboxylic acid | 0.35 | 1.8 | 0.8 | No |
| Example 7 | | | | | |

### Production of Seed Crystals (1H-Pyrrole-2,5-dicarboxylic acid)

1H-Pyrrole-2,5-dicarboxylic acid of 1.551 g and sodium formate of 1.36 g are mixed into deionized water of 50 mL, to thereby produce a mixed solution. After the mixed solution is stirred at 50° C. for 3 hours, the mixed solution is cooled to room temperature and aluminum sulfate 18-hydrate (octadecahydrate) of 3.333 g is added thereto. Next, this solution is kept at 120° C. for 12 hours. A sediment is separated by using a centrifuge and washed three times with deionized water and ethanol. Thus, MOF powder containing 1H-Pyrrole-2,5-dicarboxylic acid as the ligands is obtained as the seed crystals.

### Production of Seed Crystals (2,5-Furandicarboxylic acid)

2,5-Furandicarboxylic acid of 1.562 g and sodium formate of 1.36 g are mixed into deionized water of 50 mL, to thereby produce a mixed solution. After the mixed solution is stirred at 50° C. for 3 hours, the mixed solution is cooled to room temperature and aluminum chloride 6-hydrate (hexahydrate) of 2.413 g is added thereto. Next, this solution is kept at 100° C. for 12 hours. A sediment is separated by using the centrifuge and washed three times with deionized water and ethanol. Thus, MOF powder containing 2,5-Furandicarboxylic acid as the ligands is obtained as the seed crystals.

### Production of Seed Crystals (3,5-Pyridinedicarboxylic acid)

3,5-Pyridinedicarboxylic acid of 1.67 g and sodium formate of 1.36 g are mixed into deionized water of 50 mL, to thereby produce a mixed solution. After the mixed solution is stirred at 50° C. for 3 hours, the mixed solution is cooled to room temperature and aluminum sulfate 18-hydrate (octadecahydrate) of 3.333 g is added thereto. Next, this solution is kept at 120° C. for 12 hours. A sediment is separated by using the centrifuge and washed three times with deionized water and ethanol. Thus, MOF powder containing 3,5-Pyridinedicarboxylic acid as the ligands is obtained as the seed crystals.

### Support of Seed Crystals Onto Ceramic Support

The obtained seed crystals of 1 g are put into a glass vial bottle in which zirconia pebbles are placed, and water of 9 g is further added thereto. The glass vial bottle is set on a ball mill stand, and the seed crystals are pulverized at 60 rpm for 5 to 24 hours, to thereby obtain the seed crystals having an average particle diameter (D50) of 0.33 to 0.50 μm. After that, the seed crystals are supported onto the ceramic support.

### Example 1

1H-Pyrrole-2,5-dicarboxylic acid of 1.551 g, sodium formate of 1.22 g, and N,N-dimethylformamide of 0.58 g as the organic solvent are added to deionized water of 150 mL, to thereby produce a mixed solution. The mixed solution is stirred for 2 hours while being heated to 60° C. (heating and stirring process). After confirming that the mixed solution has become transparent, the mixed solution is cooled to room temperature. After that, aluminum sulfate 18-hydrate (octadecahydrate) of 3.333 g is added to the mixed solution, to thereby prepare a synthesis solution. In the synthesis solution, the ratio of monocarboxylic acid salt/ligands (at a molar ratio, the same applies to the following) is 1.8, and the ratio of organic solvent/ligands (at a molar ratio, the same applies to the following) is 0.8. Next, the ceramic support on which the seed crystals (whose average particle diameter is 0.33 μm) containing 1H-Pyrrole-2,5-dicarboxylic acid are supported and the above-described synthesis solution are put into a Teflon (registered trademark) container, and the hydrothermal synthesis is performed at 100° C. for 20 hours. The obtained separation membrane complex is washed three times with deionized water and ethanol and then dried.

### Example 2

Example 2 is the same as Example 1 except that the temperature of the hydrothermal synthesis is changed to 80° C.

### Example 3

Example 3 is the same as Example 1 except that the ratio of monocarboxylic acid salt/ligands is changed to 1.

### Example 4

Example 4 is the same as Example 1 except that the ratio of monocarboxylic acid salt/ligands is changed to 0.6.

### Example 5

Example 5 is the same as Example 1 except that the heating temperature in the heating and stirring process on the mixed solution is changed to 40° C. and the stirring time is changed to 5 hours.

### Example 6

Example 6 is the same as Example 1 except that the heating temperature in the heating and stirring process on the mixed solution is changed to 80° C. and the stirring time is changed to 12 hours.

### Example 7

Example 7 is the same as Example 1 except that the ratio of organic solvent/ligands is changed to 0.1.

### Example 8

Example 8 is the same as Example 1 except that the ratio of organic solvent/ligands is changed to 8.

### Example 9

Example 9 is the same as Example 1 except that the processing time of the hydrothermal synthesis is changed to 10 hours and the organic solvent is changed to N-Methylformamide.

### Example 10

Example 10 is the same as Example 1 except that the average particle diameter of the seed crystals supported onto the ceramic support is changed to 0.50 μm.

### Example 11

2,5-Furandicarboxylic acid of 1.562 g, sodium formate of 1.22 g, and N,N-dimethylformamide of 0.58 g as the organic solvent are added to deionized water of 150 mL, to thereby produce a mixed solution. The mixed solution is stirred for 2 hours while being heated to 60° C. (heating and stirring process). After confirming that the mixed solution has become transparent, the mixed solution is cooled to room temperature. After that, aluminum chloride 6-hydrate (hexahydrate) of 2.413 g is added to the mixed solution, to thereby prepare a synthesis solution. In the synthesis solution, the ratio of monocarboxylic acid salt/ligands is 1.8, and the ratio of organic solvent/ligands is 0.8. Next, the ceramic support on which the seed crystals (whose average particle diameter is 0.25 μm) containing 2,5-Furandicarboxylic acid are supported and the above-described synthesis solution are put into the Teflon container, and the hydrothermal synthesis is performed at 80° C. for 20 hours. The obtained separation membrane complex is washed three times with deionized water and ethanol and then dried.

### Example 12

Example 12 is the same as Example 11 except that the heating temperature in the heating and stirring process on the mixed solution is changed to 40° C.

### Example 13

Example 13 is the same as Example 11 except that the ratio of monocarboxylic acid salt/ligands is changed to 1.

### Example 14

Example 14 is the same as Example 11 except that the ratio of organic solvent/ligands is changed to 2.

### Example 15

3,5-Pyridinedicarboxylic acid of 1.67 g, sodium formate of 1.22 g, and N,N-dimethylformamide of 0.58 g as the organic solvent are added to deionized water of 150 mL, to thereby produce a mixed solution. The mixed solution is stirred for 2 hours while being heated to 60° C. (heating and stirring process). After confirming that the mixed solution has become transparent, the mixed solution is cooled to room temperature. After that, aluminum sulfate 18-hydrate (octadecahydrate) of 3.333 g is added to the mixed solution, to thereby prepare a synthesis solution. In the synthesis solution, the ratio of monocarboxylic acid salt/ligands is 1.8, and the ratio of organic solvent/ligands is 0.8. Next, the ceramic support on which the seed crystals (whose average particle diameter is 0.35 μm) containing 3,5-Pyridinedicarboxylic acid are supported and the above-described synthesis solution are put into the Teflon container, and the hydrothermal synthesis is performed at 100° C. for 20 hours. The obtained separation membrane complex is washed three times with deionized water and ethanol and then dried.

### Example 16

Example 16 is the same as Example 15 except that the heating temperature in the heating and stirring process on the mixed solution is changed to 40° C.

### Example 17

Example 17 is the same as Example 15 except that the ratio of monocarboxylic acid salt/ligands is changed to 1.

### Example 18

Example 18 is the same as Example 15 except that the ratio of organic solvent/ligands is changed to 2.

### Example 19

1H-Pyrrole-2,5-dicarboxylic acid of 0.775 g, 2,5-Furandicarboxylic acid of 0.781 g, lithium formate 1-hydrate (monohydrate) of 1.26 g, and N,N-dimethylformamide of 0.36 g as the organic solvent are added to deionized water of 150 mL, to thereby produce a mixed solution. The mixed solution is stirred for 2 hours while being heated to 60° C. (heating and stirring process). After confirming that the mixed solution has become transparent, the mixed solution is cooled to room temperature. After that, aluminum sulfate 18-hydrate (octadecahydrate) of 3.333 g is added to the mixed solution, to thereby prepare a synthesis solution. In the synthesis solution, the ratio of monocarboxylic acid salt/ligands is 1.5, and the ratio of organic solvent/ligands is 0.5. Next, the ceramic support on which the same seed crystals (seed crystals containing 1H-Pyrrole-2,5-dicarboxylic acid) as those in Example 1 are supported and the above-described synthesis solution are put into the Teflon container, and the hydrothermal synthesis is performed at 100° C. for 10 hours. The obtained separation membrane complex is washed three times with deionized water and ethanol and then dried.

### Example 20

1H-Pyrrole-2,5-dicarboxylic acid of 0.775 g, 3,5-Pyridinedicarboxylic acid of 0.835 g, sodium acetate of 1.51 g, and N,N-dimethylformamide of 0.36 g as the organic solvent are added to deionized water of 150 mL, to thereby produce a mixed solution. The mixed solution is stirred for 2 hours while being heated to 60° C. (heating and stirring process). After confirming that the mixed solution has become transparent, the mixed solution is cooled to room temperature. After that, aluminum sulfate 18-hydrate (octadecahydrate) of 3.333 g is added to the mixed solution, to thereby prepare a synthesis solution. In the synthesis solution, the ratio of monocarboxylic acid salt/ligands is 1.5, and the ratio of organic solvent/ligands is 0.5. Next, the ceramic support on which the same seed crystals (seed crystals containing 1H-Pyrrole-2,5-dicarboxylic acid) as those in Example 1 are supported and the above-described synthesis solution are put into the Teflon container, and the hydrothermal synthesis is performed at 100° C. for 20 hours. The obtained separation membrane complex is washed three times with deionized water and ethanol and then dried.

### Example 21

2,5-Furandicarboxylic acid of 0.781 g, 3,5-Pyridinedicarboxylic acid of 0.781 g, potassium formate of 1.47 g, and N,N-dimethylformamide of 0.58 g as the organic solvent are added to deionized water of 150 mL, to thereby produce a mixed solution. The mixed solution is stirred for 2 hours while being heated to 60° C. (heating and stirring process). After confirming that the mixed solution has become transparent, the mixed solution is cooled to room temperature. After that, aluminum sulfate 18-hydrate (octadecahydrate) of 3.333 g is added to the mixed solution, to thereby prepare a synthesis solution. In the synthesis solution, the ratio of monocarboxylic acid salt/ligands is 1.5, and the ratio of organic solvent/ligands is 0.8. Next, the ceramic support on which the same seed crystals (seed crystals containing 2,5-Furandicarboxylic acid) as those in Example 11 are supported and the above-described synthesis solution are put into the Teflon container, and the hydrothermal synthesis is performed at 100° C. for 20 hours. The obtained separation membrane complex is washed three times with deionized water and ethanol and then dried.

### Comparative Example 1

Comparative Example 1 is the same as Example 1 except that the heating and stirring process is not performed.

### Comparative Example 2

Comparative Example 2 is the same as Comparative Example 1 except that the ratio of monocarboxylic acid salt/ligands is changed to 0 (in other words, no monocarboxylic acid salt is added). Further, in Comparative Example 2, no separation membrane is generated on the support.

### Comparative Example 3

Comparative Example 3 is the same as Example 1 except that the ratio of organic solvent/ligands is changed to 12.

### Comparative Example 4

Comparative Example 4 is the same as Example 1 except that the ratio of organic solvent/ligands is changed to 0 (in other words, no organic solvent is added).

### Comparative Example 5

A synthesis solution is produced by the method and with the composition disclosed in

“Multivariate Polycrystalline Metal-Organic Framework Membranes for CO₂/CH₄ Separation” by Weidong Fan, et. al., (J. Am. Chem. Soc., 2021, Vol. 143, pp. 17716 to 17723) (above-described Document 1), and like in Document 1, membrane formation is performed without using any seed crystals. In Comparative Example 5, the entire surface of the support on which membrane formation is to be performed cannot be covered with the separation membrane.

### Comparative Example 6

Comparative Example 6 is the same as Comparative Example 5 except that the same seed crystals (seed crystals containing 2,5-Furandicarboxylic acid) as those in Example 11 are used.

### Comparative Example 7

Comparative Example 7 is the same as Example 15 except that the heating and stirring process is not performed.

### Measurement and Evaluation of Separation Membrane Complex

Various measurements are performed on the separation membrane complex in each of Examples 1 to 21 and Comparative Examples 1 to 7. Table 4 shows the average thickness of the separation membrane, the thickness of the composite layer, the average particle diameter of the separation membrane, the CO₂ permeance, and the permeance ratio of SF₆/He.

TABLE 4

| | | Thick- | Average | | |
|---|---|---|---|---|---|
| | Average | ness | Particle | | |
| | Thickness | of | Diameter | | |
| | of | Com- | of | CO₂ | |
| | Separation | posite | Separation | Per- | Permeance |
| | Membrane | Layer | Membrane | meance | Ratio |
| | (μm) | (μm) | (μm) | (GPU) | of SF₆/He |
| Example 1 | 2 | 1.9 | 0.30 | 2000 | 0.015 |
| Example 2 | 1.7 | 1.5 | 0.26 | 2100 | 0.016 |
| Example 3 | 2 | 1.9 | 0.35 | 2000 | 0.008 |
| Example 4 | 1.9 | 1.7 | 0.30 | 2400 | 0.009 |
| Example 5 | 1.9 | 1.2 | 0.40 | 2290 | 0.010 |
| Example 6 | 1.8 | 1.2 | 0.10 | 2445 | 0.005 |
| Example 7 | 2 | 1.5 | 0.31 | 2300 | 0.015 |
| Example 8 | 2 | 1.9 | 0.25 | 2030 | 0.018 |
| Example 9 | 1 | 1 | 0.20 | 4500 | 0.005 |
| Example 10 | 1.5 | 1 | 0.30 | 3200 | 0.012 |
| Example 11 | 2 | 1.9 | 0.30 | 1050 | 0.005 |
| Example 12 | 1.7 | 1.5 | 0.26 | 1200 | 0.011 |
| Example 13 | 1 | 1 | 0.20 | 2000 | 0.010 |
| Example 14 | 1.7 | 1.3 | 0.30 | 1250 | 0.008 |
| Example 15 | 2 | 1.9 | 0.30 | 1200 | 0.015 |
| Example 16 | 2 | 1.9 | 0.30 | 1100 | 0.017 |
| Example 17 | 2 | 1.9 | 0.40 | 1100 | 0.011 |
| Example 18 | 1.9 | 1.8 | 0.28 | 1450 | 0.015 |
| Example 19 | 1 | 1 | 0.2 | 3000 | 0.004 |
| Example 20 | 1 | 1 | 0.25 | 2950 | 0.004 |
| Example 21 | 2 | 1.3 | 0.40 | 1010 | 0.011 |
| Com- | 2.5 | 1.9 | 2.2 | 1900 | 0.05 |
| parative | | | | | |
| Example 1 | | | | | |
| Com- | — | — | — | — | No |
| parative | | | | | Separation |
| Example 2 | | | | | Membrane |
| | | | | | is Generated |
| Com- | 2 | 1.9 | 0.25 | 1900 | 0.061 |
| parative | | | | | |
| Example 3 | | | | | |
| Com- | 2 | 1.5 | 0.31 | 2000 | 0.023 |
| parative | | | | | |
| Example 4 | | | | | |
| Com- | 3 | 2 | 5 | — | Poor |
| parative | | | | | Coverage |
| Example 5 | | | | | with |
| | | | | | Separation |
| | | | | | Membrane |
| Com- | 2.5 | 2 | 2.3 | 750 | 0.101 |
| parative | | | | | |
| Example 6 | | | | | |
| Com- | 2 | 1.8 | 3 | 950 | 0.029 |
| parative | | | | | |
| Example 7 | | | | | |

The average thickness of the separation membrane, the thickness of the composite layer, and the average particle diameter of the separation membrane are measured by the cross-sectional observation using the SEM, as described earlier. In Examples 1 to 21, the average thickness of the separation membrane is not larger than 2 μm, and the thickness of the composite layer is not larger than 2 μm. In Comparative Examples 1 and 3 to 7, the thickness of the composite layer is not larger than 2 μm, but the average thickness of the separation membrane is not smaller than 2 μm. In Comparative Example 2, as described above, no separation membrane is generated on the support. In Examples 1 to 21, the average particle diameter of the separation membrane is smaller than 0.5 μm, but in Comparative Examples 1 and 5 to 7, the average particle diameter of the separation membrane is larger than 2 μm. Further, when the powder X-ray diffraction measurement is performed on the MOF composing the separation membrane of Examples 1 to 21, the acquired powder X-ray diffraction pattern has peaks at the diffraction angles 2θ shown in above-described Table 2.

Furthermore, on each of CO₂ gas, SF₆ gas, and He gas, the permeance of a single gas is measured by using the above-described separation apparatus 2. Further, in Comparative Examples 2 and 5 in which poor formation of the separation membrane occurs, the permeance is not measured. In each of Examples 1 to 21, the CO₂ permeance is not lower than 1000 GPU, and high permeance is achieved. On the other hand, in each of Comparative Examples 6 and 7, the CO₂ permeance is lower than 1000 GPU. Furthermore, 1 GPU is 1×10⁻⁶ cm³ (STP)/(cm²·sec·cmHg). Further, in each of Examples 1 to 21, a ratio of the permeance of SF₆ gas to the permeance of He gas, i.e., the permeance ratio of SF₆/He is not higher than 0.020. On the other hand, in all Comparative Examples (Comparative Examples 1, 3, 4, 6, and 7) in which the permeance is measured, the permeance ratio of SF₆/He is higher than 0.020.

When many grain boundary defects each of which refers to formation of an excessively large gap between crystals of the MOF or many coordination defects each of which refers to a lack of some ligands constituting the MOF are present in the separation membrane, a high separation factor cannot be achieved. Since it is expected, in the above-described separation membrane, that the grain boundary defect or the coordination defect has a defect size of 0.5 nm or more, in the present preferred embodiment, the quantity of defects in the separation membrane is evaluated by the permeance ratio of SF₆ gas having a dynamic molecular diameter of 0.56 nm and He gas having a dynamic molecular diameter which is sufficiently smaller than that of SF₆ gas. In each of Examples 1 to 21, as described above, the permeance ratio of SF₆/He is not higher than 0.020, and SF₆ gas hardly permeates the separation membrane. Therefore, in the separation membrane complex of each of Examples 1 to 21, the grain boundary defect and the coordination defect are reduced and a high separation factor can be achieved. On the other hand, in all Comparative Examples in which the permeance is measured, the permeance ratio of SF₆/He is higher than 0.020, and much SF₆ gas permeates the separation membrane. Therefore, in the separation membrane complex of each of Comparative Examples, the separation factor becomes lower due to effects of the grain boundary defect and the coordination defect.

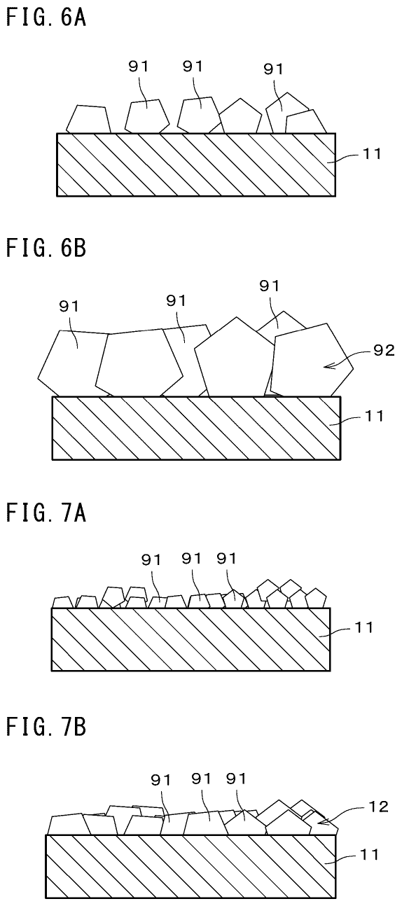

Herein, reasons why the permeance ratio of SF₆/He is reduced (the separation factor becomes higher) in the separation membrane complex of each of Examples 1 to 21 will be considered. FIGS. 6A and 6B are views used for explaining synthesis of a separation membrane 92 in Comparative Example in which the average particle diameter is relatively large. FIGS. 7A and 7B are views used for explaining synthesis of the separation membrane 12 in Examples 1 to 21 in which the average particle diameter is relatively small. FIGS. 6A and 7A each show an initial state of the membrane synthesis and FIGS. 6B and 7B each show a state at the end of the membrane synthesis.

In the synthesis of the separation membrane 92 in Comparative Example, as shown in FIG. 6A, it is thought that the particle diameter of MOF crystals 91 becomes large in an initial stage of the membrane synthesis. In this case, a gap between the MOF crystals 91 becomes large and the grain boundary defect becomes easy to occur. In order to fill the gap between the MOF crystals 91, as shown in FIG. 6B, it is necessary to grow the MOF crystals 91 to be larger and the thickness of the separation membrane 92 becomes larger. In other words, in the separation membrane having an average thickness of about 2 μm, the separation factor becomes lower.

On the other hand, in Examples 1 to 21, since the separation membrane 12 is synthesized by the secondary growth method using the seed crystals having a small average particle diameter (e.g., not larger than 0.5 μm), the particle diameter of the MOF crystals 91 is small in the initial stage of the membrane synthesis as shown in FIG. 7A. Therefore, the gap between the MOF crystals 91 becomes smaller and the grain boundary defect becomes hard to occur. Further, also at the end of the membrane synthesis where the average thickness is not larger than 2 μm, as shown in FIG. 7B, a state where the average particle diameter of the separation membrane 12 (the average particle diameter of the MOF crystals 91) is small, specifically 0.1 to 2 μm, is kept, and occurrence of the grain boundary defect is suppressed.

Though the reason why the average particle diameter of the separation membrane becomes smaller is not necessarily clear, since the average particle diameter is larger than 2 μm in each of Comparative Examples 1, 6, and 7 in which no heating and stirring process is performed, it is thought that the heating and stirring process contributes thereto. In the heating and stirring process, it is thought that by heating and melting the ligands to be used as a starting material of the synthesis solution, a precursor of the MOF in the synthesis solution is adsorbed to the seed crystals and thereby stabilized, and it is estimated that this produces an effect on the formation of the above-described MOF membrane. In the separation membrane complex of each of Examples 1 to 21, by reducing the average particle diameter, it is possible to reduce the average thickness of the separation membrane (to 2 μm or less) and easily achieve a high permeance. Further, it becomes possible to reduce the grain boundary defect to thereby make the permeance ratio of SF₆/He not higher than 0.020, in other words, to thereby achieve a high separation factor. In the separation membrane complex, actually, the thickness of the composite layer of the support and the MOF also becomes not larger than 2 μm and the permeance of CO₂ gas becomes not lower than 1000 GPU.

In the synthesis of the MOF membrane, it is thought that the organic solvent (and monocarboxylic acid) competes against the ligands, to thereby repeat coordination/dissociation to/from metal ions, and the growth speed of the crystals is thereby reduced and the MOF having high crystallinity is obtained. Therefore, in a case where no organic solvent is added, the crystallinity of the MOF becomes lower. On the other hand, in a case where the organic solvent is excessively added, it is thought that the MOF is formed with the organic solvent being coordinated and the coordination defect becomes easy to occur (see Comparative Example 3). In Examples 1 to 21, in the synthesis solution, by setting the molar ratio of the organic solvent containing the carbonyl group and the ligands (ratio of organic solvent/ligands) to be 0.1 to 10, the MOF having high crystallinity is obtained while the coordination defect is reduced, and a high separation factor is thereby achieved.

Further, in the synthesis solution, in a case where no monocarboxylic acid salt is added, it is thought that deprotonation of the ligands is hard to occur and the synthesis solution becomes cloudy and the uniformity is reduced, and the separation membrane thereby becomes harder to generate (see Comparative Example 2). On the other hand, in a case where monocarboxylic acid salt is excessively added, it is thought that the MOF is formed while monocarboxylic acid is coordinated thereto and the coordination defect thereby becomes easier to occur (see Comparative Example 6). In Examples 1 to 21, in the synthesis solution, by setting the ratio of monocarboxylic acid salt/ligands to be 0.5 to 1.8, the coordination defect is reduced and the uniformity of the synthesis solution is ensured, and an appropriate separation membrane can be thereby obtained.

As described above, the separation membrane complex 1 includes the porous support 11 formed of ceramic and the separation membrane 12 which is formed on the support 11 and composed of MOF. The average thickness of the separation membrane 12 is not larger than 2 μm. The MOF is composed of aluminum ions and the ligands coordinated to the aluminum ions. The powder X-ray diffraction pattern of the MOF has peaks at diffraction angles 2θ shown in above-described Table 2. In the separation membrane complex 1, the permeance ratio of SF₆/He is not higher than 0.020. In such a separation membrane complex 1, it is possible to achieve both a high separation factor and a high permeance.

Preferably, the average particle diameter of the MOF is 0.1 μm to 2 μm. It is thereby possible to reduce the grain boundary defect and increase the separation factor in the thin separation membrane 12.

Preferably, the ligands of the MOF contain any one of 1H-Pyrrole-2,5-dicarboxylic acid, 2,5-Furandicarboxylic acid, and 3,5-Pyridinedicarboxylic acid. Thus, by using the ligands having high affinity with CO₂, it is possible to increase the permeance of CO₂ gas.

Preferably, the thickness of the composite layer 13 of the support 11 and the MOF is not larger than 2 μm. It is thereby possible to achieve a higher permeance in the separation membrane complex 1.

Preferably, the permeance of CO₂ gas is not lower than 1000 GPU. It thereby becomes possible to suitably perform separation of the CO₂ gas. Depending on the purpose of use of the separation membrane complex 1, the permeance of CO₂ gas may be lower than 1000 GPU.

The method of producing the separation membrane complex 1 includes a step of depositing the seed crystals composed of the MOF onto the porous support 11 (Step S12), a step of preparing the synthesis solution (Step S13), and a step of forming the separation membrane 12 on the support 11 by immersing the support 11 in the synthesis solution and performing the hydrothermal synthesis to grow the MOF from the seed crystals (Step S14). Step S13 includes the heating and stirring process for heating and stirring the solution in which water, monocarboxylic acid salt, and the ligands are mixed. In Step S13, the A1 source is mixed into the solution after the heating and stirring process and the organic solvent is mixed into the solution at arbitrary timing. In the separation membrane complex 1 in which the separation membrane 12 is formed on the support 11, the permeance ratio of SF₆/He is not higher than 0.020. It is thereby possible to provide the separation membrane complex 1 having both a high separation factor and a high permeance.

In the ordinary synthesis of the MOF, the environmental load increases since a large amount of organic solvent such as methanol, ethanol, or DMF is used. On the other hand, when the synthesis is performed without using any organic solvent, it is impossible to appropriately form the MOF membrane. In contrast to this, in a preferable method of producing the separation membrane complex 1, the above-described organic solvent is an organic compound having a carbonyl group, and in the synthesis solution, the ratio of the amount of substance of the organic solvent to that of the ligands is 0.1 to 10. It thereby becomes possible to appropriately form the MOF membrane and reduce the amount of usage of the organic solvent, to thereby reduce the environmental load.

Preferably, in the synthesis solution, the ratio of the amount of substance of the monocarboxylic acid salt to that of the ligands is 0.5 to 1.8. It is thereby possible to appropriately form the MOF membrane and reduce the coordination defect, to thereby increase the separation factor.

In the above-described separation membrane complex 1 and the above-described method of producing the separation membrane complex 1, various modifications can be made.

In the separation membrane complex 1, only if both a high separation factor and a high permeance can be achieved, the average particle diameter of the MOF may be out of the range from 0.1 μm to 2 μm or the thickness of the composite layer 13 of the support 11 and the MOF may be larger than 2 μm. Similarly, in the synthesis solution, the ratio of organic solvent/ligands may be out of the range from 0.1 to 10 or the ratio of monocarboxylic acid salt/ligands may be out of the range from 0.5 to 1.8.

In the production of the separation membrane complex 1, in a case where the synthesis solution contains two or more types of ligands (see Examples 19 to 21), the ligands contained in the MOF of the seed crystals may be different from the two or more types of ligands. Further, mixture of a plurality of types of MOF powders containing different ligands may be used as the seed crystals. In a case where the synthesis solution contains only one type of ligands, the ligands contained in the MOF of the seed crystals may be the same as or different from the one type of ligands.

The separation membrane complex 1 may further include a function layer or a protective layer laminated on the separation membrane 12, additionally to the support 11 and the separation membrane 12. Such a function layer or a protective layer may be an inorganic membrane such as a zeolite membrane, a silica membrane, a carbon membrane, or the like or an organic membrane such as a polyimide membrane, a silicone membrane, or the like. Further, a substance that is easy to adsorb a specific molecule such as CO₂ or the like may be added to the function layer or the protective layer laminated on the separation membrane 12.

The separation membrane complex 1 may be produced by any method other than the above-described production method.

In the separation apparatus 2 and the separation method, any substance other than the substances exemplarily shown in the above description may be separated from the mixed substance.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### Industrial Applicability

The separation membrane complex of the present invention can be used in various fields as a separation membrane, an adsorption membrane, or the like for any of various substances.

### Reference Signs List

1 Separation membrane complex
11 Support
12 Separation membrane
13 Composite layer
S11 to S14, S21, S22 Step

1. A separation membrane complex, comprising:
a porous support formed of ceramic; and
a separation membrane which is formed on said support and composed of metal organic framework,
wherein an average thickness of said separation membrane is not larger than 2 μm,
said metal organic framework is composed of aluminum ions and ligands coordinated to said aluminum ions,
a powder X-ray diffraction pattern of said metal organic framework has peaks at diffraction angles 2θ shown in Table below, and
a permeance ratio of SF₆/He is not higher than 0.020.
TABLE 1

| | 2θ [°] |
|---|---|
| [symbol] | 8.2-8.4 |
| [symbol] | 9.1-9.3 |
| [symbol] | 11.8-12.0 |
| [symbol] | 12.4-12.6 |
| [symbol] | 14.9-15.1 |
| [symbol] | 16.7-16.9 |
| [symbol] | 17.1-17.3 |
| [symbol] | 18.4-18.6 |
| [symbol] | 19.1-19.3 |
| [symbol] | 22.5-22.7 |
| [symbol] | 24.3-24.5 |
| [symbol] | 25.1-25.3 |
| [symbol] | 26.9-27.1 |

2. The separation membrane complex according to claim 1, wherein
an average particle diameter of said metal organic framework is 0.1 μm to 2 μm.

3. The separation membrane complex according to claim 1, wherein
said ligands of said metal organic framework contain any one of 1H-Pyrrole-2,5-dicarboxylic acid, 2,5-Furandicarboxylic acid, and 3,5-Pyridinedicarboxylic acid.

4. The separation membrane complex according to claim 1, wherein
a thickness of a composite layer of said support and said metal organic framework is not larger than 2 μm.

5. The separation membrane complex according to claim 1, wherein
a permeance of CO₂ gas is not lower than 1000 GPU.

6. A method of producing a separation membrane complex, comprising:
a) depositing seed crystals composed of metal organic framework onto a porous support;
b) preparing a synthesis solution; and
c) forming a separation membrane on said support by immersing said support in said synthesis solution and performing hydrothermal synthesis to grow metal organic framework from said seed crystals,
wherein said operation b) includes a heating and stirring process for heating and stirring a solution in which water, monocarboxylic acid salt, and ligands are mixed,
an aluminum source is mixed into said solution after said heating and stirring process and an organic solvent is mixed into said solution at arbitrary timing in said operation b), and
a permeance ratio of SF₆/He is not higher than 0.020 in a separation membrane complex in which said separation membrane is formed on said support.

7. The method of producing a separation membrane complex according to claim 6, wherein
said organic solvent is an organic compound having a carbonyl group, and
a ratio of an amount of substance of said organic solvent to that of said ligands is 0.1 to 10 in said synthesis solution.

8. The method of producing a separation membrane complex according to claim 6, wherein
a ratio of an amount of substance of said monocarboxylic acid salt to that of said ligands is 0.5 to 1.8 in said synthesis solution.
